(19) United States
(12) Patent Application Publication
(10) Pub. No.: US 2018/0264493 A1
(43) Pub. Date: Sep. 20, 2018

(54) Sports Water Bottle with Mister

(71) Applicant: Ever Win International Corporation, City of Industry, CA (US)

(72) Inventors: Yasuhiro Yamamoto, Los Angeles, CA (US); Mae Hsu, Pasadena, CA (US)

(73) Assignee: Ever Win International Corporation, City of Industry, CA (US)

(21) Appl. No.: 15/459,357

(22) Filed: Mar. 15, 2017

(51) Int. Cl. B05B 11/00; A45F 3/18; B65D 1/02; B65D 41/04; B05B 15/00

(52) U.S. Cl. CPC B05B 11/0086; A45F 3/18; B65D 1/0246; B05B 11/3059; B05B 15/005; B05B 11/3047; B65D 41/04

(57) ABSTRACT

A sports water bottle with mister is a portable water bottle with a dual function top affixed to it that is capable of both a large flow of water for drinking and also spraying of water for cooling. The dual function top comprises a slidable nozzle that functions both as a water flow opening and closing mechanism and also as a pump mechanism to force the water in the water bottle out through a small spray nozzle in the dual function top.

### BACKGROUND

### Field of Invention

The present invention relates generally to water bottles. More specifically, the present invention relates to a water bottle that uses a unitary dual function top to enable the user to either drink from the dual function top or spray water from the nozzle in the dual function top.

### BACKGROUND

### Description of Related Art

Water bottles are commonly used to store and carry water. Small portable water bottles are commonly used by people engaging in sports activities to carry water with them for drinking. Traditionally, portable water bottles are manufactured from plastic materials for its low cost and light weight. These portable water bottles are generally elongated cylinders with a sealed bottom and with a threaded opening at the top that is closed by a matching threaded plastic cap. To drink water from these portable water bottles, the user must first remove the threaded cap and then pour the water out from the threaded opening. After drinking, the user must replace the threaded cap on the threaded opening to close the portable water bottle and prevent foreign matters from entering the portable water bottle and contaminate the water therein.

An improved version of the portable water bottle for drinking replaces the threaded cap with a reclosable nozzle that is operated by pulling and pushing on the reclosable nozzle to open and close the nozzle. Generally, by pulling on the reclosable nozzle, a water path is opened through the top of the reclosable nozzle to enable the water to flow out of the portable water bottle. By pushing down on the reclosable nozzle, the water path is sealed and no water will flow out of the portable water bottle and the water inside the portable water bottle is sealed from foreign contaminants.

Small portable water bottles are also used for spraying water for its cooling effects either during hot weather or during vigorous exercise. These portable water bottles are commonly equipped with a pump mechanism that forces the water out through a small nozzle that either sprays the water in a stream, spray, or a misting pattern. The pump mechanism is commonly actuated by the user by squeezing a trigger. Actuation of the pump mechanism forces the water out through the nozzle. The water spray, particularly in a misting form, has a cooling effect as it absorbs the heat energy and evaporates.

For a portable water bottle to have both the water drinking function and water spraying function, prior arts require two separate openings in the portable water bottle and two separate nozzles affixed to the portable water bottle. This increases both the complexity and the cost of the portable water bottle.

### BRIEF SUMMARY OF THE INVENTION

The sports water bottle with mister is a portable water bottle with a dual function top affixed to it that is capable of both a large flow of water for drinking and also spraying of water for cooling. The dual function top has a slidable nozzle that functions both as a water flow opening and closing mechanism and also as a pump mechanism to force the water contained therein out through a small spray nozzle in the dual function top. An elongated tube is affixed under the dual function top and extends to near the bottom of the portable water bottle to enable the extraction of the water through the spray nozzle.

The sports water bottle of the present invention only has a unitary dual function top that functions both as a drinking opening and also as a pump with a spray nozzle. The dual function top may be retrofitted to most preexisting water bottles that have a threaded cap, a reclosable drinking cap, or a spray nozzle. The sports water bottle of the present invention is multifunctional and is easy to operate with a unitary dual function top.

### BRIEF DESCRIPTION OF THE DRAWINGS

FIG. 1 shows a perspective view of the preferred embodiment of the sports water bottle with mister with a dust cap covering the dual function top.

FIG. 2 shows a perspective enlarged view of the preferred embodiment of the dual function top.

FIG. 3 shows a perspective enlarged cut-away view of the preferred embodiment of the dual function top in the closed/uncompressed position.

FIG. 4 shows a perspective enlarged cut-away view of the preferred embodiment of the dual function top in the open position that enable a flow of water out the top opening for drinking.

FIG. 5 shows a perspective enlarged cut-away view of the preferred embodiment of the dual function top in the closed/compressed pump position that enables the sliding dual function top to function as a pump to force water out through the spray nozzle by pushing down on the sliding dual function top.

FIG. 6 shows a perspective enlarged cut-away view of another embodiment of the dual function top without the protrusion around the spray nozzle and without the cut-out under the slidable nozzle in the closed/uncompressed position.

FIG. 7 shows a perspective enlarged cut-away view of another embodiment of the dual function top without the protrusion around the spray nozzle and without the cut-out under the slidable nozzle in the open position that enable a flow of water out the top opening for drinking.

FIG. 8 shows a perspective enlarged cut-away view of another embodiment of the dual function top without the protrusion around the spray nozzle and without the cut-out under the slidable nozzle in the closed/compressed pump position that enables the sliding dual function top to function as a pump to force water out through the spray nozzle by pushing down on the sliding dual function top.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

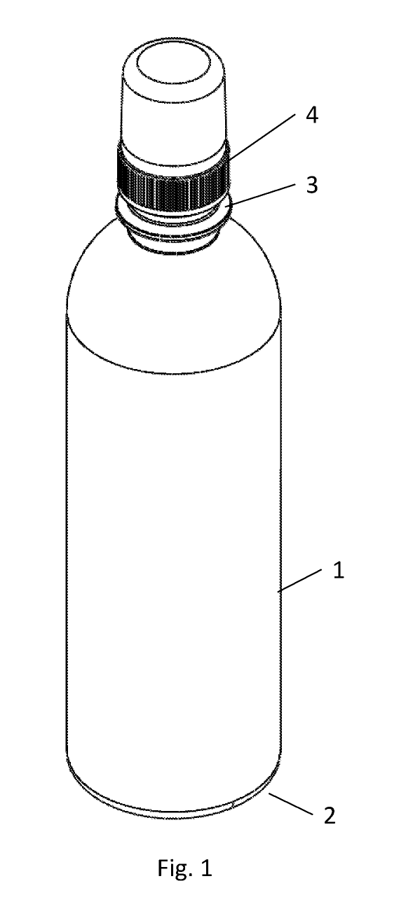

The sports water bottle with mister as shown in FIG. 1 is a portable water bottle 1 with a dual function top 4 affixed to it that is capable of both a large flow of water for drinking and also spraying of water for cooling. In the preferred embodiment, the water bottle 1 is a cylindrical plastic container with a sealed bottom 2 and a constricted open top with a threaded opening 3. The water bottle 1 may also be made of other suitable materials such as aluminum or other metal alloys. The water bottle 1 may also be in different shapes other than cylindrical.

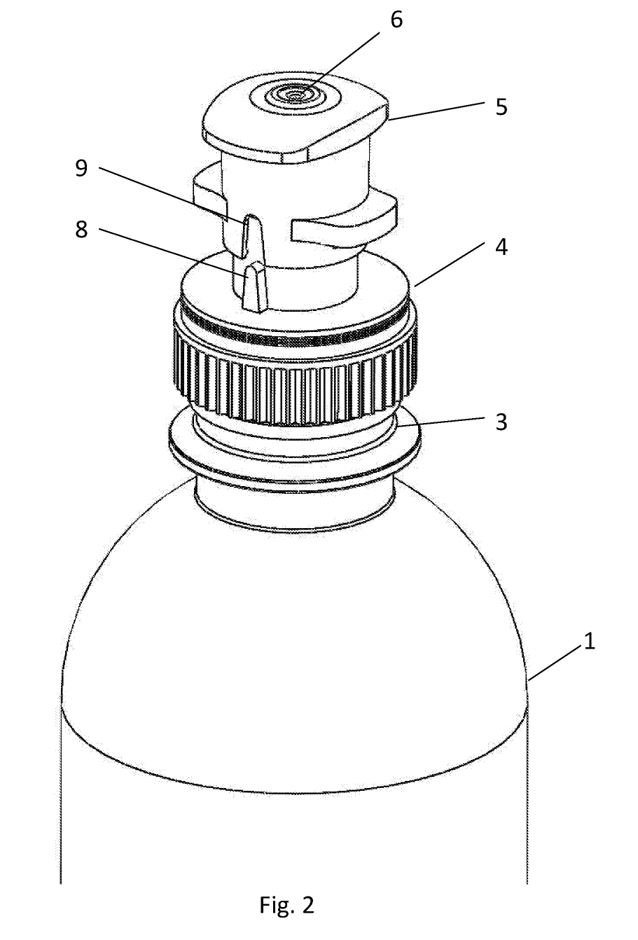

In the preferred embodiment, the dual function top 4 has a threaded bottom that acts as a cap to removably attach to the threaded opening 3 on the water bottle 1 thereby closing the opening 3 of the water bottle 1. As shown in FIGS. 2 through 8, the dual function top 4 has a slidable nozzle 5 that functions both as a water flow opening and closing mechanism and also as a pump mechanism to force the water contained in the water bottle 1 out through a small spray nozzle 6 in the center of the dual function top 4. The slidable nozzle 5 surrounds the spray nozzle 6 in its center and has an opening at its top to enable the water to flow out of the water bottle 1 as well to enable the spray nozzle 6 to spray water out the top of the dual function top 4. An elongated tube 7 is affixed under the dual function top 4 and extends to near the bottom of the water bottle 1 to enable the extraction of the water from the water bottle 1 through the spray nozzle 6 when the slidable nozzle 5 is operated as a pump. Openings are provided around the spray nozzle 6 to enable the water in the water bottle 1 to flow around the spray nozzle 6 and out through the opening at the top of the slidable nozzle 5 when the water bottle 1 is inverted.

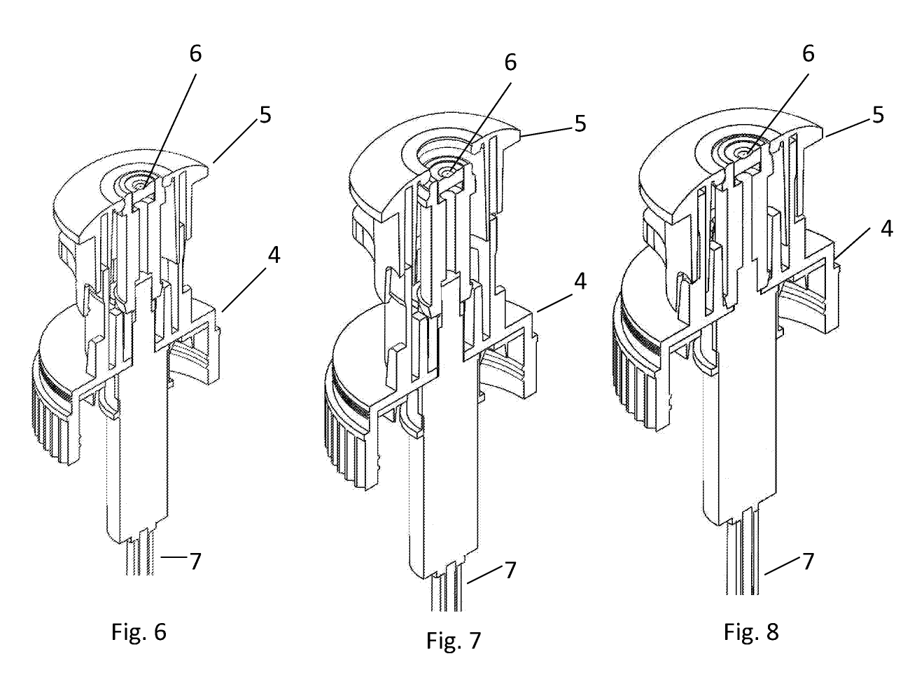

In the closed position shown in FIGS. 2, 3, and 6, the slidable nozzle 5 is in a lowered position approximately the same height as the spray nozzle 6 and seals around the spray nozzle 6 thereby closing the water path from the water bottle 1 around the spray nozzle 6. In this closed position, the water in the water bottle 1 is sealed from outside foreign contaminants and no water will flow out of the water bottle 1 even if the water bottle 1 is inverted. When the slidable nozzle 5 is pulled up away from the water bottle 1 as shown in FIGS. 4 and 7, the spray nozzle 6, it is in the open position. In this open position, the slidable nozzle 5 is raised to a higher position relative to the spray nozzle 6. The seal between the slidable nozzle 5 and the spray nozzle 6 is separated and opened. If the water bottle 1 is inverted while the slidable nozzle 5 is in the open position, the water in the water bottle 1 will flow through the openings around the spray nozzle 6 and out through the opening between the slidable nozzle 5 and the spray nozzle 6 for drinking.

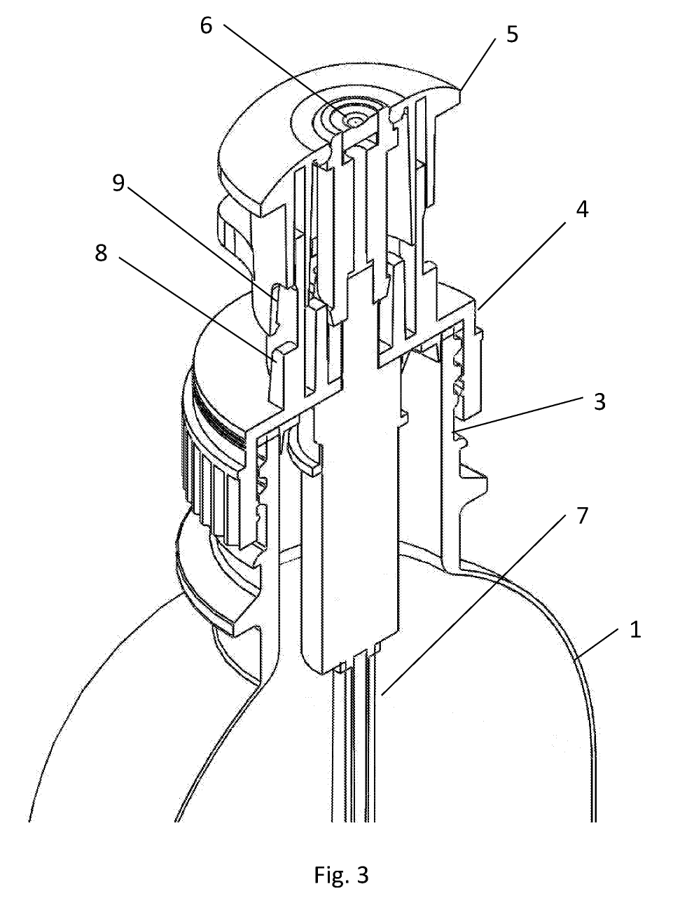

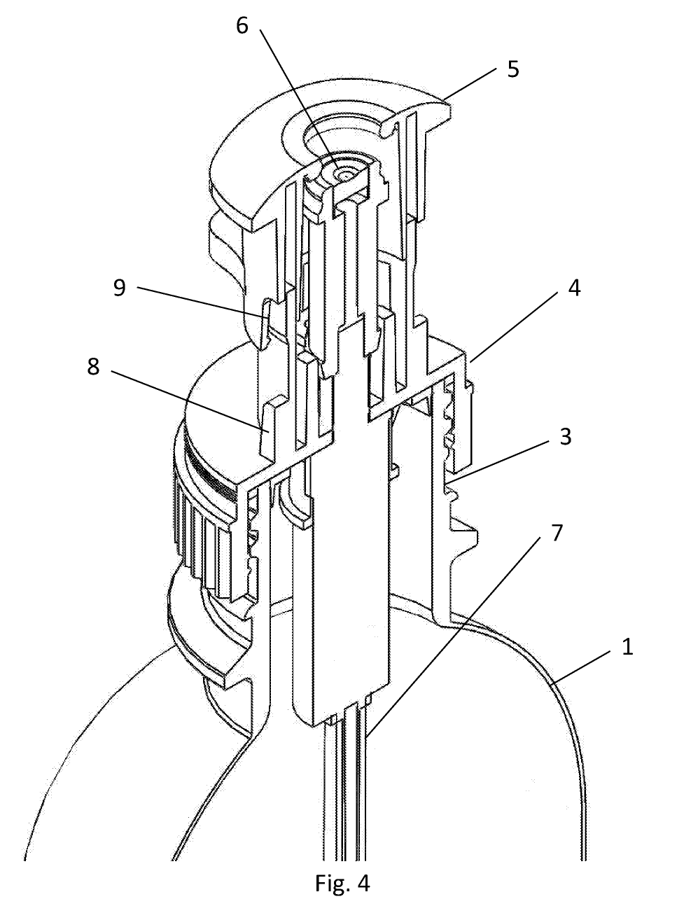

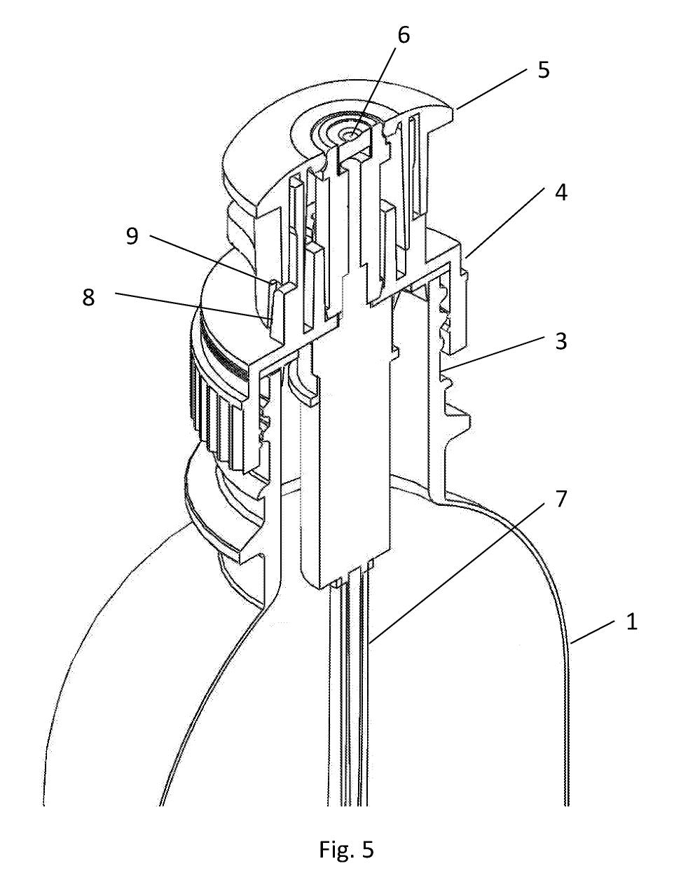

In a preferred embodiment shown in FIGS. 2 through 5, a protrusion 8 is provided at a predetermined position on the outside circumference of the spray nozzle 6 under the bottom edge of the slidable nozzle 5. A corresponding cut-out 9 is provided on the bottom edge of the slidable nozzle 5 to enable the slidable nozzle 5 to slide down around the protrusion 8 on the spray nozzle 6 when the cut-out 9 is positioned directly above the corresponding protrusion 8 on the spray nozzle 6. The bottom edge of the slidable nozzle 5 is positioned a predetermined distance above the protrusion 8 on the spray nozzle 6. As shown in FIG. 4, the slidable nozzle 5 may slide up above the protrusion 8 on the spray nozzle 6 to open the water flow path around the spray nozzle 6 or, as shown in FIG. 3, may slide down to just above the protrusion 8 to close the water flow path around the spray nozzle 6. As shown in FIG. 5, the cut-out 9 enables the slidable nozzle 5 to further slide down on top of the protrusion 8 around the spray nozzle 6 thereby actuating the pump function to spray water out of the spray nozzle 6. If the cut-out 9 is rotated out of alignment with the protrusion 8 around the spray nozzle 6, the slidable nozzle 5 cannot slide down further, thereby locking out the pump function and prevents accidental spraying of the water from the spray nozzle 6.

To activate the pump mechanism to spray water out of the spray nozzle 6, the slidable nozzle 5 is rotated to align the cut-out 9 on the bottom edge with the corresponding protrusion 8 on the slidable nozzle 6 to enable the slidable nozzle 5 to slide down around the spray nozzle 6 and actuating the pump function. Upon downward compression of the slidable nozzle 5, it functions as a pump to pump the water in the water bottle 1 up through the elongate tube 7 under the spray nozzle 6 and spray out through the spray nozzle 6 in the center of the slidable nozzle 5. Optionally, an urging means such as a spring may be disposed under the slidable nozzle 5 to return the slidable nozzle 5 to its closed, non-compression position after it is actuated. The slidable nozzle 5 may be actuated repeatedly to provide multiple sprays of water out of the spray nozzle 6. The slidable nozzle 5 may be rotated so that the cut-out 9 on its bottom edge is out of alignment with the protrusion 8 around the spray nozzle 6 to lock out the spray function. The slidable nozzle 5 may alternatively be pulled all the way up away from the spray nozzle 6 to open the water flow around the spray nozzle 6 and enable the water to flow around the spray nozzle 6 and out of the water bottle 1 for drinking when the water bottle 1 is inverted.

The sports water bottle of the present invention only has a single top that functions both as a drinking opening and also as a pump with a spray nozzle 6. The dual function top 4 may be retrofitted to most preexisting water bottles that may have a threaded cap, a reclosable drinking cap, or a spray nozzle. The sports water bottle of the present invention is multifunctional, low cost, and is easy to operate with a single sliding dual function top 4.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1: A dual function top for a sports water bottle with mister comprising:
a slidable nozzle defining an opening;
a spray nozzle disposed in said slidable nozzle and exposed through said opening; and
an elongated tube affixed under said spray nozzle;
wherein said slidable nozzle is slidable from a closed position to an open position to open a fluid path between the slidable nozzle and the spray nozzle and alternatively to a closed position to first close said fluid path and subsequently spray water from said spray nozzle.

2: A dual function top for a sports water bottle with mister as in claim 1, further including a protrusion at a predetermined position on the outside circumference of said spray nozzle and a corresponding cut-out on a bottom edge of said slidable nozzle.

3: A dual function top for a sports water bottle with mister as in claim 2, wherein said slidable nozzle is rotatable to align said cut-out with said protrusion on said spray nozzle and also to rotate said cut-out out of alignment with said protrusion.

4: A dual function top for a sports water bottle with mister as in claim 1, wherein said slidable nozzle and said spray nozzle are attachable to a container.

5: A dual function top for a sports water bottle with mister comprising:
a spray nozzle with an opening that is capable of spraying liquid;
an elongated tube affixed under said spray nozzle in fluid communication with a liquid; and
a slidable nozzle slidable on said spray nozzle;
wherein said slidable nozzle is slidable from a closed position to an open position wherein a fluid path is opened between the slidable nozzle and the spray nozzle and alternatively to a closed position wherein said fluid path is first closed and subsequently liquid may be sprayed from said spray nozzle by further actuating said slidable nozzle.

6: A dual function top for a sports water bottle with mister as in claim 5, further including a protrusion at a predetermined position on the outside circumference of said spray nozzle and a corresponding cut-out on a bottom edge of said slidable nozzle.

7: A dual function top for a sports water bottle with mister as in claim 6, wherein said slidable nozzle is rotatable to align said cut-out with said protrusion on said spray nozzle and also to rotate said cut-out out of alignment with said protrusion.

8: A dual function top for a sports water bottle with mister as in claim 5, wherein said slidable nozzle and said spray nozzle are attachable to a container.

9: A sports water bottle with mister comprising:
a container for water with a sealed end and an open end;
a dual function top attached to said open end of said container comprising;
a slidable nozzle defining an opening;
a spray nozzle disposed in said slidable nozzle and exposed through said opening; and
an elongated tube affixed under said spray nozzle and extends into said container;
wherein said slidable nozzle is slidable from a closed position to an open position to open a fluid path between the slidable nozzle and the spray nozzle and alternatively to a closed position to first close said fluid path and subsequently spray water from said spray nozzle.

10: A sports water bottle with mister as in claim 9, wherein said container is a plastic cylindrical water bottle with a threaded opening.

11: A sports water bottle with mister as in claim 9, wherein said container is a plastic cylindrical water bottle with a threaded opening.

12: A sports water bottle with mister as in claim 9, wherein a protrusion is disposed at a predetermined position on the outside circumference of said spray nozzle and a corresponding cut-out is defined on a bottom edge of said slidable nozzle.

13: A sports water bottle with mister as in claim 12, wherein said slidable nozzle is rotatable to align said cut-out with said protrusion on said spray nozzle and also to rotate said cut-out out of alignment with said protrusion.
